(19) United States
(12) Patent Application Publication
(10) Pub. No.: US 2013/0137492 A1
(43) Pub. Date: May 30, 2013

(54) THROUGHPUT CONTROL ADJUSTABLE VANES ON AGRICULTURAL COMBINE HARVESTER

(71) Applicant: AGCO Corporation, Duluth, GA (US)

(72) Inventors: Joseph M. Biggerstaff, Wichita, KS (US); Alan R. Bergkamp, Galva, KS (US); Bernard D. Regier, Newton, KS (US)

(73) Assignee: AGCO CORPORATION, Duluth, GA (US)

(21) Appl. No.: 13/688,920

(22) Filed: Nov. 29, 2012

Related U.S. Application Data
(60) Provisional application No. 61/564,704, filed on Nov. 29, 2011.

(51) Int. Cl. A01F 12/28

(52) U.S. Cl. CPC A01F 12/28
USPC 460/62

(57) ABSTRACT

A threshing mechanism for a combine harvester has a cylindrical rotor for moving crop materials and a plurality of separator tines secured thereon for threshing crop material. A rotor chamber has a top casing forming an upper portion defining a volume of space between the rotor and the top casing. A plurality of crop transport vanes extend away from an inward surface of the top casing to direct the crop material generally helically along the chamber. The vanes have a rotor-facing edge at an outer end away from the inward surface of the top casing. The vanes are positionable between a base position and at least one extended position with respect to the rotor, wherein in the base position, the rotor-facing edge is positioned a greater distance from the rotor than when in the at least one extended position.

### CROSS REFERENCE TO RELATED APPLICATIONS

This application claims priority to U.S. Provisional Application No. 61/564,704 filed Nov. 29, 2011, entitled “THROUGHPUT CONTROL ADJUSTABLE VANES ON AGRICULTURAL COMBINE HARVESTER”.

### BACKGROUND OF THE INVENTION

1. Field of Invention

This invention relates to the crop processing systems of combine harvesters, and more particularly to adjustable crop flow control vanes in the threshing mechanism of the combine

2. Description of Related Art

In one type of processing system for combine harvesters, the crop travels axially parallel to and helically around the rotational axis of one or more rotary processing devices commonly referred to as rotors. In other systems, during at least a portion of its travel through the system the crop travels in a transverse or tangential direction relative to the rotational axis of a rotary processing device commonly referred to as a threshing cylinder. In each case, grain is processed between elements affixed to the periphery of the rotary device and arcuate, usually foraminous, stationary processing members in the form of threshing concaves or separating grates that partially wrap around the lower portion of the rotor.

It is known to mount a plurality of vanes on the inner surface of a rotor casing to assist in directing the movement of the crop material. The crop transport vanes cooperate with the rotor of the mechanism to direct the crop material generally helically through the threshing mechanism of the combine to conveniently control the rate of movement of the material through the mechanism. Because processing systems are utilized to harvest a wide variety of different crops, they must function properly in many different operating conditions. Generally, axial rotor combines perform best when the region between the rotor and rotor casing is full or operating at the upper end of its capacity. If a large capacity rotor is operating in conditions that cannot keep the region at full capacity, whether it be poor yielding crop or header limited, the amount of grain lost from the processing system increases. It would be desirable to adjust the running clearance in the region between the rotor and the rotor casing to best accommodate variables that may be encountered.

### OVERVIEW OF THE INVENTION

In one embodiment, the invention relates to a combine harvester having a threshing mechanism. The threshing mechanism includes a generally cylindrical elongated rotor for moving crop materials, and a plurality of separator tines secured thereon for threshing crop material. A generally cylindrical elongated rotor chamber surrounds the rotor and receives crop material at an open end to be threshed and separated. The rotor is journalled for rotation within the chamber. The rotor chamber has a top casing forming an upper portion of the rotor chamber, with the top casing defining a volume of space between the rotor and the top casing for processing the crop material. The threshing mechanism also includes a plurality of crop transport vanes extending away from an inward surface of the top casing in radially spaced relation to the separator tines on the rotor for coacting with the bars upon rotation of the rotor to direct the crop material generally helically along the chamber. The vanes have a rotor-facing edge at an outer end away from the inward surface of the top casing. The vanes are positionable between a base position and at least one extended position with respect to the rotor, wherein in the base position, the rotor-facing edge is positioned a greater distance radially from the rotor than when in the at least one extended position. The vanes are radially adjustable between the base position and the at least one extended position to adjust the distance between the rotor-facing edge and the rotor. The threshing mechanism also has an operating mechanism for adjusting the radial position of the vanes relative to the rotor to selectively vary the rate of movement of the crop material through the chamber.

These and other features and advantages of this invention are described in, or are apparent from, the following detailed description of various example embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a schematic side elevation view of a combine harvester having a processing system utilizing axial flow and incorporating the principles of the present invention, portions of the harvester being broken away to reveal internal details of construction;

FIG. 2 is a rear elevation view of the processing system illustrating the threshing concave assembly in its fully closed position to minimize the running clearance between the rotor and the concave assembly; and

FIG. 3 is a rear elevation view of the processing system similar to FIG. 2 but illustrating the concave assembly in an open position increasing the running clearance between the rotor and the concave assembly.

Corresponding reference characters indicate corresponding parts throughout the views of the drawings.

### DESCRIPTION OF EXAMPLE EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

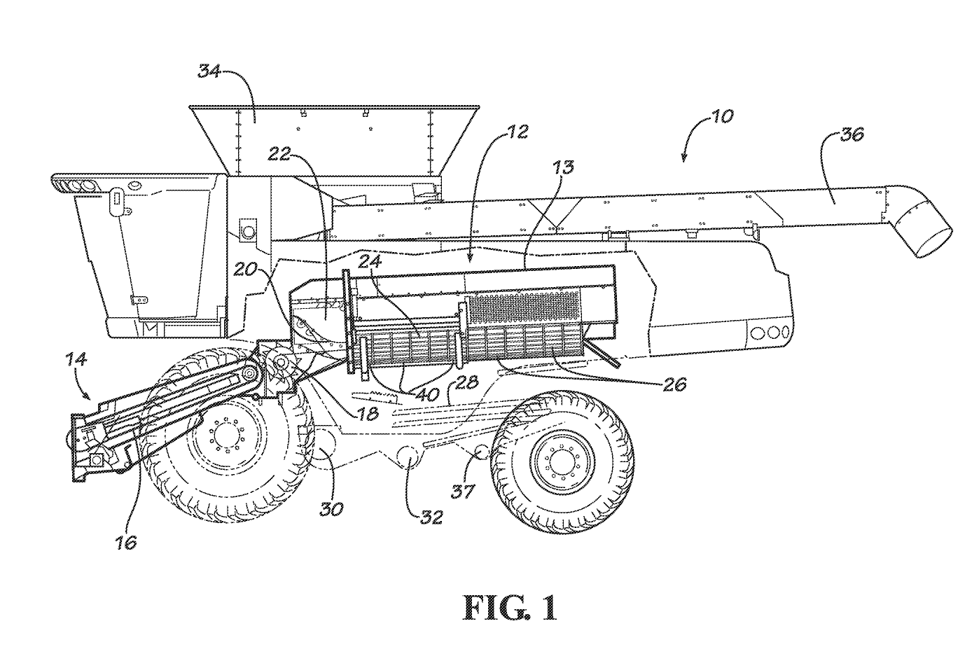

The exemplary combine harvester 10 selected for illustration in FIG. 1 has a single axial flow processing system 12 that extends generally parallel with the path of travel of the machine. However, as will be seen, the principles of the present invention are not limited to harvesters with processing systems designed for axial flow, nor to axial flow harvesters having only a single such processing system. However, for the sake of simplicity in explaining the principles of the present invention, this specification will proceed utilizing a single axial flow processing system as the primary example.

As well understood by those skilled in the art, in the illustrated embodiment combine harvester 10 includes a harvesting header (not shown) at the front of the machine that delivers collected crop materials to the front end of a feeder house 14. Such materials are moved upwardly and rearwardly within feeder house 14 by a conveyer 16 until reaching a beater 18 that rotates about a transverse axis. Beater 18 feeds the material upwardly and rearwardly to a rotary processing device, in this instance to a rotor 22 having an infeed auger 20 on the front end thereof. Auger 20, in turn, advances the materials axially into the processing system 12 for threshing and separating. In other types of systems, conveyor 16 may deliver the crop directly to a threshing cylinder.

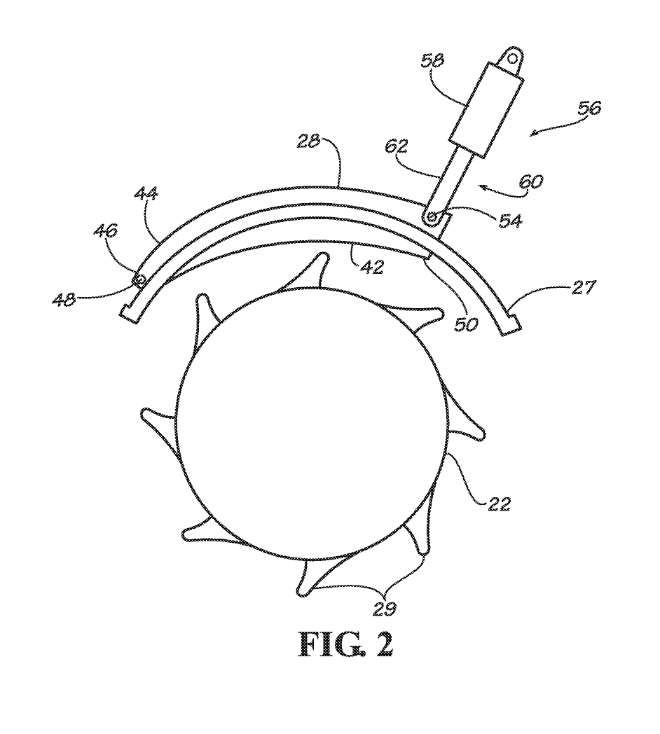

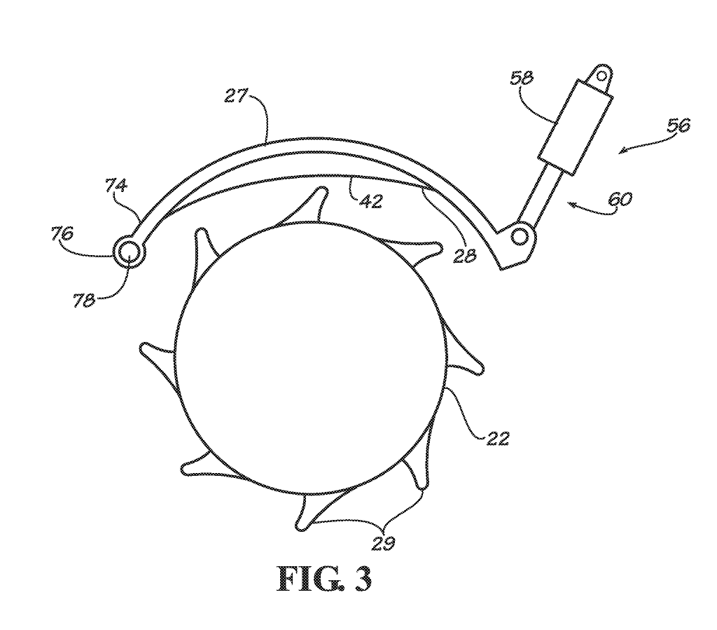

Generally speaking, the crop materials entering processing system 12 move axially and helically therethrough during threshing and separating. During such travel the crop materials are threshed and separated by generally cylindrical rotor 22 operating in a generally cylindrical chamber 23 which concentrically receives the rotor 22. The lower part of the chamber 23 contains a threshing concave assembly 24 and a separator grate assembly 26. The upper part of the chamber contains a top casing 27. A plurality of vanes 28 (FIGS. 2, 3) are disposed in successively spaced apart and generally parallel relation along the interior of the top casing 27 throughout the length of the chamber 23. Rotation of the rotor 22 impels the crop material rearwardly in a generally helical direction about the rotor 22 as guided by the vanes 28. A plurality of separator tines 29 (FIG. 2) mounted on the cylindrical surface of the rotor 22 cooperate with the concave assembly 24 and separator grate assembly 26 to thresh and separate the crop material, with the grain escaping laterally through concave assembly 24 and separator grate assembly 26 into cleaning mechanism 30. Bulkier stalk and leaf materials are retained by the concave assembly 24 and the separator grate assembly 26 and are impelled out the rear of processing system 12 and ultimately out of the rear of the machine.

A blower 31 forms part of the cleaning mechanism 30 and provides a stream of air throughout the cleaning region below processing system 12 and directed out the rear of the machine so as to carry lighter chaff particles away from the grain as it migrates downwardly toward the bottom of the machine to a clean grain auger 32. Auger 32 delivers the clean grain to an elevator (not shown) that elevates the grain to a storage bin 34 on top of the machine, from which it is ultimately unloaded via an unloading spout 36. A returns auger 37 at the bottom of the cleaning region is operable in cooperation with other mechanism (not shown) to reintroduce partially threshed crop materials into the front of processing system 12 for an additional pass through the processing system 12.

As is known in the art, the concave assembly 24 is desirably made of a plurality of concaves 40 positioned axially along the forward portion of the rotor 22. Each concave 40 wraps around a bottom portion of the rotor 22 in a circumferential manner. In the illustrated embodiment of FIG. 1, the concave assembly 24 contains six substantially identical concaves 40. However, the concave assembly 24 may contain more or fewer concaves 40 without departing from the scope of the invention. Concaves 40 in the concave assembly 24 also may be arranged in side-by-side pairs with one concave 40 of each pair positioned along one side of the rotor 22 and the other concave 40 of each pair positioned on the opposite side of the rotor 22. The concave assembly 24 may be adapted to move the concaves 40 toward and away from rotor 22 so as to adjust the running clearance between rotor 22 and concave assembly 24 and to change the shape of the threshing region.

With reference now to FIGS. 2 and 3, the vanes 28 are disposed in successively spaced apart and generally parallel relation along the interior of the top casing 27 along the length of the chamber 23. While one vane 28 is shown in FIGS. 2 and 3 for convenience, other vanes 28 may be substantially similar and therefore need not be described herein. In one embodiment, seven such vanes 28 are utilized. However, one skilled in the art will understand that more or fewer vanes 28 may be used. Each vane 28 has a rotor-facing edge 42 that is a segment of a circle having a diameter generally conforming to the interior surface of the top chamber 27. In accordance with the invention the vanes 28 are pivotally mounted with respect to the rotor 22 so as to selectively move the rotor-facing edge 42 of the vanes 28 closer or further away from the rotor 22 to adjust the running clearance between rotor 22 and vanes 28 and to change the shape of the threshing region. It is believed that positioning the vanes 28 closer to the rotor 22 reduces the throughput of the processing system 12 and allows more aggressive threshing by making the crop have more revolutions in the processing system 12.

In one embodiment depicted in FIG. 2, each vane 28 is pivotally mounted at its proximal end 44 on the top casing 27 at hinge point 46, which defines a pivot axis disposed parallel to the axis of the rotor 22. In one embodiment, a first pivot shaft 48 extends longitudinally of the top casing 27 on the exterior thereof and the proximal end 44 of each of the vanes 28 is pivotally secured to pivot shaft 48. The rotor-facing edge 42 and distal end 50 of each vane 28 extend through respective slots 52 defined through the stationary top casing 27. A rock shaft 54 is mounted on the exterior of the top casing 27 parallel to the first pivot shaft 48. The rock shaft 54 is secured to the distal end 50 of each vane 28.

An operating mechanism, broadly denoted by numeral 56, is mounted on the rock shaft 54 and adjustably moves the vanes 28 toward and away from rotor 22 to adjust the position of the rotor-facing edge 42 of each vane 28 relative to rotor 22. The operating mechanism 56 contains an actuator 58 and a linkage assembly, broadly denoted by numeral 60, connecting the actuator 58 to the rock shaft 54. Preferably, the actuator 58 is remotely operable, such as from the cab of harvester 10. In one embodiment, the actuator 58 comprises an electrically powered linear actuator. However, one skilled in the art will understand that the actuator 58 may be selected from a number of different actuating devices known in the art, such as a hydraulic cylinder or a turnbuckle, for example. Such actuators 58 are well known to one skilled in the art and need not be described in detail herein. In one embodiment, the linkage assembly 60 includes a lever 62 connecting the actuator 58 to the rock shaft 54. However, the linkage assembly 60 may contain other structural components chosen using sound engineering judgment. In the illustrated embodiment, the hinge point 46 about which the vane 28 pivots is located at the proximal end 44 of the vane 28 and the vanes 28 are mounted on a common rockshaft 54 at the distal end 50 of the vanes 28. However, one skilled in the art will understand that the rockshaft 54 may be located at other positions relative the vanes 28, such as near the middle of the vanes 28, using sound engineering judgment. Additionally, it is to be understood that each vane 28 may have is own operating mechanism 56 without departing form the scope of the invention.

FIG. 3 illustrates a second embodiment of a processing system 12 with pivoting vanes 28. In the illustrated embodiment, the vanes 28 are fixedly mounted on the interior surface of the top casing 27 and the top casing 27 is pivotally mounted with respect to the rotor 22. The top casing 27 is pivotally mounted at its proximal end 74 about a hinge axis 76. The hinge axis 76 is aligned substantially parallel to the axis of the rotor 22. In one embodiment, a pivot shaft 78 extends longitudinally of the top casing 27 and the proximal end 74 of the top casing 27 is pivotally secured to the pivot shaft 78. The operating mechanism 56 adjustably moves the top casing 27 and the vanes 28 mounted thereon toward and away from rotor 22 to adjust the position of the vanes 28 relative to rotor 22.

In operation position of the vanes 28 relative the rotor 22 controls the running clearance between rotor 22 and vanes 28 and thus the shape of the threshing region. Positioning the vanes 28 closer to the rotor 22 reduces the throughput of the processing system 12 and allows more aggressive threshing by making the crop have more revolutions in the processing system 12 as the rotor 26 moves crop material in a generally helical path through the casing. As crop types and conditions may require, the amount of insertion of the vanes 28 may be selectively varied to vary the flow rate of material through the processing system 12.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

What is claimed is:

1. A threshing mechanism for a combine harvester comprising:
a generally cylindrical elongated rotor for moving crop materials, said rotor having a plurality of separator tines secured thereon for threshing crop material;
a generally cylindrical elongated rotor chamber surrounding said rotor and having an open end for reception of crop material to be threshed and separated, said elongated rotor being journalled for rotation about its axis within said chamber, wherein said rotor chamber comprises a top casing forming an upper portion of said rotor chamber, said top casing defining a volume of space between said rotor and said top casing;
a plurality of crop transport vanes extending away from an inward surface of said top casing in radially spaced relation to the separator tines on said rotor for coacting with said tines upon rotation of said rotor to direct the crop material generally helically along said chamber, said vanes having a rotor-facing edge at an extended end away from the inward surface of said top casing, said vanes having a base position and at least one extended position with respect to the rotor, wherein in said base position, said rotor-facing edge is positioned a greater distance radially from the rotor than when in said at least one extended position, and wherein said vanes are adjustable between said base position and said at least one extended position to adjust the radial distance between the rotor-facing edge and the rotor; and
an operating mechanism for adjusting the position of said vanes relative to the rotor to selectively vary the rate of movement of the crop material through said chamber.

2. The threshing mechanism for a combine harvester of claim 1 wherein the vanes are pivotally mounted with respect to the rotor so as to selectively move the rotor-facing edge of the vanes closer or further away from the rotor to adjust the running clearance between rotor and vanes.

3. The threshing mechanism for a combine harvester of claim 2 wherein each of said plurality of vanes is pivotally mounted at its proximal end on the top casing at a hinge point, wherein the hinge points of said plurality of vanes define a pivot axis disposed parallel to the axis of the rotor.

4. The threshing mechanism for a combine harvester of claim 3 wherein the pivot axis is formed by a pivot shaft extending longitudinally of the top casing and the proximal end of each of the vanes are pivotally secured to pivot shaft.

5. The threshing mechanism for a combine harvester of claim 4 wherein the rotor-facing edge and distal end of each vane extend through respective slots defined through the top casing.

6. The threshing mechanism for a combine harvester of claim 4 further comprising a rock shaft is mounted on the exterior of the top casing parallel to the pivot shaft, the rock shaft being is secured to the distal end of each of the plurality of vanes.

7. The threshing mechanism for a combine harvester of claim 4 wherein the operating mechanism is mounted on the rock shaft and adjustably moves the vanes toward and away from rotor to adjust the position of the rotor-facing edge of each vane relative to rotor.

8. The threshing mechanism for a combine harvester of claim 4 wherein the operating mechanism comprises an actuator and a linkage assembly connecting the actuator to the rock shaft.

9. The threshing mechanism for a combine harvester of claim 4 wherein the actuator comprises an electrically powered linear actuator.

10. The threshing mechanism for a combine harvester of claim 1 wherein the plurality of vanes are fixedly mounted on the interior surface of the top casing and the top casing is pivotally mounted with respect to the rotor such that the operating mechanism adjustably moves the top casing and the plurality of vanes mounted thereon toward and away from rotor to adjust the position of the plurality vanes relative to rotor.

11. The threshing mechanism for a combine harvester of claim 10 wherein the top casing is pivotally mounted at its proximal end along a hinge axis, the hinge axis being disposed parallel to the axis of the rotor.

12. The threshing mechanism for a combine harvester of claim 11 further comprising a pivot shaft extending longitudinally of the top casing and the proximal end of the top casing is pivotally secured to the pivot shaft.

13. The threshing mechanism for a combine harvester of claim 1 further comprising a semi cylindrical concave disposed to define a lower portion of said chamber and through which the grain exits from said chamber in response to crop threshing action of said separator tines.
